(19) United States
(12) Patent Application Publication
(10) Pub. No.: US 2024/0240037 A1
(43) Pub. Date: Jul. 18, 2024

(54) ULTRA-VIOLET RESISTANT COATING COMPOSITION

(71) Applicant: PRC-Desoto International, Inc., Sylmar, CA (US)

(72) Inventors: Guangliang Tang, Stevenson Ranch, CA (US); Mikhail Khudiakov, Mason, OH (US); Zhen Ye, Valencia, CA (US)

(73) Assignee: PRC-Desoto International, Inc., Sylmar, CA (US)

(21) Appl. No.: 18/554,216

(22) PCT Filed: Apr. 8, 2022
(86) PCT No.: PCT/US2022/071636

§ 371 Date: Oct. 6, 2023

Related U.S. Application Data
(60) Provisional application No. 63/172,611, filed on Apr. 8, 2021.

(51) Int. Cl. C09D 5/32; C08J 5/04; C08J 7/04; C08J 7/043; C09D 5/00; C09D 5/33; C09D 7/40; C09D 7/61; C09D 163/00

(52) U.S. Cl. CPC C09D 5/32; C08J 5/042; C08J 7/042; C08J 7/043; C09D 5/002; C09D 5/004; C09D 7/61; C09D 7/67; C09D 7/68; C09D 163/00; C08J 2463/00

(57) ABSTRACT

The present invention relates to a coating composition including a film-forming resin present in an amount of 20 percent to 60 percent by weight of the total solids of the coating composition; an amount of a first material comprising a reflective property towards ultraviolet light; and an amount of a second material comprising an absorptive property towards ultraviolet light. A substrate comprising a surface at least partially coated with the coating composition. A method of preparing a substrate including coating a portion of a surface of the substrate with the coating composition and curing the coating composition. A vehicle comprising a surface at least partially coated with the coating composition.

### FIELD

The present disclosure relates to the field of ultra-violet resistant coating compositions.

### BACKGROUND

Aerospace manufacturers are building aircraft bodies with more than 50 percent by weight of carbon fiber composites to achieve lower operating costs, better fuel economy, and reduced carbon dioxide emissions compared with previous-generation aircraft. However, carbon fiber composites based on aromatic polymers, e.g., carbon fibers in a thermoset aromatic epoxy matrix, which may be referred to as carbon fiber reinforced polymers (CFRPs), are sensitive to ultraviolet (UV) radiation with wavelengths between 280 nanometers (nm) and 400 nm (UVA: 400-315 nm and UVB: 315-280 nm). The energy associated with such wavelengths is comparable to the bond dissociation energies of the polymeric materials, meaning these wavelengths can dissociate molecular bonds in polymers that may lead to the degradation of the materials. UV-induced degradation can include a loss of surface gloss, surface discoloration, chalking, flaking of surface resin, pitting, microcracking, and a severe loss of resin in glass-reinforced (GRP) composites.

### SUMMARY

A coating composition is described. The coating composition comprises a film-forming resin present in an amount of 20 percent to 60 percent by weight of the total solids of the coating composition; an amount of a first material comprising a reflective property towards ultraviolet light; and an amount of a second material comprising an absorptive property towards ultraviolet light.

A substrate comprising a surface at least partially coated with the coating composition is also described.

A method of preparing a substrate is further described. The method comprises coating a portion of a surface of the substrate with the coating composition and curing the coating composition.

A vehicle comprising a surface at least partially coated with the coating composition is still further described.

### BRIEF DESCRIPTION OF THE DRAWINGS

FIG. 1 illustrates the transmission intensity data of control coating composition samples and coating composition samples made as described herein with amounts on a quartz substrate in a wavelength range of 290 nanometers (nm) to 550 nm as plotted with 0.4 percent of maximum transmission.

FIG. 2 illustrates the transmission intensity data of control coating composition samples and coating composition samples made as described herein with amounts on a quartz substrate in a wavelength range of 290 nanometers (nm) to 550 nm as plotted with one percent of maximum transmission.

### DETAILED DESCRIPTION

For purposes of the following detailed description, it is to be understood that the invention may assume various alternative variations and step sequences except where expressly specified to the contrary. Moreover, other than in any operating examples, or where otherwise indicated, all numbers expressing, for example, quantities of ingredients used in the specification and claims, are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

As used herein, unless otherwise expressly specified, all numbers such as those expressing values, ranges, amounts or percentages may read as if prefaced by the word “about”, even if the term does not expressly appear. Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this description, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “an” aerospace component, “a” pigment, and the like refer to one or more of these items. Still further, as used herein, the term “polymer” may refer to prepolymers, oligomers, and both homopolymers and copolymers. The term “resin” is used interchangeably with “polymer.”

As used herein, “including.” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described. In general, the open-ended terms such as “comprising”, “including.” “containing” and “consisting essentially of” also include the closed terms.

As used herein, the terms “on,” “onto,” “applied on.” “applied to,” “applied onto,” “formed on,” “deposited on.” “deposited onto,” “coated on” mean formed, overlaid, deposited, or provided on but not necessarily in contact with the surface. For example, a coating composition “applied onto” a substrate does not preclude the presence of one or more other intervening coating layers of the same or different composition located between the coating composition and the substrate.

A coating composition is described that may be applied to a substrate to form a coating that has a property to inhibit a transmission of ultraviolet (UV) radiation, particularly UV radiation with a wavelength of 280 nm to 550 nm, through the coating and protect the substrate or a surface of the substrate from degradation due to UV radiation exposure. The coating composition comprises, consists essentially of or consists of a film-forming resin; an amount of a first material comprising a reflective property towards ultraviolet light; and an amount of a second material comprising an absorptive property towards ultraviolet light. The coating composition may be applied as a single coating on a substrate or may be applied with other coating compositions, such as the coating composition as described herein provided as a base coat such as a primer over which a topcoat or topcoats may be applied. The coating composition may also be applied onto another coating composition, such as but not limited to being applied between a base coat and a topcoat. In addition to serving as a coating or film that inhibits a transmission of UV radiation and high energy radiation therethrough and protects a substrate from degradation to UV and high energy radiation, a coating composition as a coating or film on substrate may also serve as a sealant or protective layer to seal and/or protect an underlying layer or substrate.

The coating composition includes a film-forming resin. As used herein, the term “film-forming resin” refers to resins that can form a self-supporting continuous film on a surface of a substrate upon removal of any diluents (e.g., solvents) or carriers or solvents present in the coating composition or upon curing at ambient or elevated temperature. Film-forming resins that may be used in the coating compositions as described herein include, without limitation, those used in aerospace coating compositions, automotive OEM coating compositions, automotive refinish coating compositions, industrial coating compositions, architectural coating compositions, and coil coating compositions, among others.

A suitable film-forming resin may be an epoxy amine resin. Epoxy amine resin coating compositions are used in the aerospace industry as primers for paints or topcoats, such as primers for aircraft components. The primer provides an intermediate layer that forms a strong bond with the underlying surface and provides an outer surface to which topcoats can bond strongly. Many epoxy amine resins also provide chemical, water and other fluid resistance. Epoxy amine resins may include a resin formed from the reaction of a first component (e.g., an epoxy functional polymer) with a second component (e.g., a polyamine). A coating composition as described herein may include a resin which may be a two component (2K) system with the first component and the second component contained separately until mixed (combined) to form a coating composition that is then applied to a substrate.

A first component of an epoxy amine resin may include one or more epoxides such as diglycidyl ethers of bisphenol A, bisphenol F, glycerol, novolacs, and the like. Exemplary suitable polyepoxides include, but are not limited to, those having a 1,2-epoxy equivalency greater than 1, such as up to and including 3.0. Examples of such epoxides are polyglycidyl ethers of polyhydric phenols and of aliphatic alcohols. These polyepoxides can be produced by etherification of the polyhydric phenol or aliphatic alcohol with an epihalohydrin such as epichlorohydrin in the presence of alkali. Examples of suitable polyhydric phenols are 2,2-bis(4-hydroxyphenyl) propane (bisphenol A), 1,1-bis(4-hydroxyphenyl) ethane and bis(4-hydroxyphenyl) propane. Examples of suitable aliphatic alcohols are ethylene glycol, diethylene glycol, 1,2-propylene glycol and 1,4-butylene glycol. Also, cycloaliphatic polyols such as 1,2-cyclohexanediol, 1,4-cyclohexanediol, 1,2-bis(hydroxymethyl)cyclohexane and hydrogenated bisphenol A can be used.

Besides the epoxy-containing polymers described above, certain polyepoxide monomers and oligomers can also be used. Examples include diepoxides such as 3,4-epoxycyclohexylmethyl-3,4-epoxycyclohexane carboxylate, bis(3,4-epoxy-6-methylcyclohexyl-methyl) adipate, bis(2,3-epoxycyclopentyl) ether, vinyl cyclohexane dioxide, 2-(3,4-cpoxycyclohexyl)-5,5-spiro(2,3-epoxycyclohexane)-m-dioxane, bis(3,4-epoxycyclohexylmethyl)adipate, and the like. Examples of polyepoxides are 3,4-epoxycyclohexylmethyl 3,4-epoxycyclohexanecarboxylate and bis(3,4-epoxy-6-methylcyclohexyl-methyl) adipate.

The second component of the epoxy amine resin may include one or more polyamines such as aliphatic amines and adducts, cycloaliphatic amines, amidoamines and polyamides. Exemplary suitable polyamines can be primary or secondary diamines or polyamines in which the radicals attached to the nitrogen atoms can be saturated or unsaturated, aliphatic, aliphatic-substituted, alicyclic, alicyclic-substituted, aromatic, aromatic-substituted aliphatic, aliphatic-substituted aromatic or heterocyclic. Mixed amines in which the radicals are different such as, for example, aromatic and aliphatic can be employed and other non-reactive groups (e.g., groups that do not participate in a curing reaction) can be present attached to the carbon atom, such as oxygen, sulfur, halogen or nitroso. Exemplary of suitable aliphatic and alicyclic diamines are the following: 1,2-ethylene diamine, 1,2-propylene diamine, 1,8-menthane diamine, isophorone diamine, propane-2,2-cyclohexyl amine and methane-bis-(4-cyclohexyl amine), and NH₂(CH₂CH(CH₃)O)ₓCH₂CH(CH₃)NH₂, where x=1 to 10. Aromatic diamines such as the phenylene diamines and the toluene diamines can also be utilized. Exemplary of the aforesaid amines are o-phenylene diamine and p-tolylene diamine. N-alkyl and N-aryl derivatives of the above amines can be employed such as, for example, N,N′-dimethyl-o-phenylene diamine, N,N′-di-p-tolyl-m-phenylene diamine, and p-amino-diphenylamine. Polynuclear aromatic diamines can further be utilized in which the aromatic rings are attached by means of a valence bond such as, for example, 4,4′-biphenyl diamine, methylene dianiline and monochloromethylene dianiline.

A curing reaction between a first component (e.g., an epoxy functional polymer) and a second component (e.g., a polyamine) may be assisted with a tertiary amine catalyst, such as tris-(dimethylaminomethyl)-phenol included in the first component and/or the second component.

The first component (e.g., an epoxy functional polymer) and/or the second component (e.g., a polyamine) of an epoxy amine resin may include an organic solvent as a diluent to form a solvent-borne coating composition when the first component and the second component are mixed for application to a substrate. Suitable solvents include, but are not limited to, ketone, acetate, glycol, alcohol and aromatic solvents. Exemplary suitable solvents include, but are not limited to, aromatic petroleum distillates like toluene, xylene, and aromatic blends commercially available from Exxon Corporation like SOLVESSO 100 and SOLVESSO 150; aliphatic solvents like cyclohexane and naphtha's; ketone solvents like acetone, methyl ethyl ketone, methyl isobutyl ketone, and methyl amyl ketone; alcohols like ethyl alcohol, propyl alcohol, butyl alcohol and diacetone alcohol; mono- and dialkyl ethers of ethylene and diethylene glycol like ethylene glycol monoethyl ether, ethylene glycol monobutyl ether, ethylene glycol monoethyl ether acetate, diethylene glycol monobutyl ether, and diethylene glycol diethyl ether. In addition, or as an alternative to epoxy-resin film-forming resins, the film-forming resin can include thermosetting film-forming resins. As used herein, the term “thermosetting” refers to resins that “set” irreversibly upon curing or crosslinking, wherein the polymer chains of the polymeric components are joined together by covalent bonds. This property is usually associated with a cross-linking reaction of the composition constituents often induced, for example, by heat or radiation. Curing or crosslinking reactions also may be carried out under ambient conditions. Once cured or crosslinked, a thermosetting resin will generally not melt upon the application of heat and is insoluble in solvents. Suitable thermosetting film-forming resins include polyurethane, polyester, polyacrylic, polysulfide and polysiloxane resins.

Other film-forming resins include thermoplastic film-forming resins. As used herein, the term “thermoplastic” refers to resins that comprise polymeric components that are not joined by covalent bonds and thereby can undergo liquid flow upon heating and are soluble in solvents. Examples of thermoplastic film-forming resins include, but are not limited to, polyvinyl chloride and polypropylene resins.

The film-forming resin (e.g., for a 2K system such as an epoxy amine resin including a first component and a base component) may be present in the coating composition in an amount of 20 percent to 60 percent by weight of the total solids of the coating composition, such as 20 percent to 55 percent by weight, such as 25 percent to 50 percent by weight, such as 30 percent to 45 percent by weight and such as 35 percent to 40 percent by weight. For a 2K system, the coating composition comprises a kit where the first component and the second component are separated until use. For example, the kit may be two separate containers packaged together or separately, one container including the first component and the other container containing the second component.

In addition to a film-forming resin, a coating composition as described herein includes an amount of a first material comprising a reflective property towards UV light and an amount of a second material comprising an absorptive property towards ultraviolet light. For a 2K system such as an epoxy amine resin including a first component and a base component, each of the amount of the first material (comprising a reflective property towards UV light) and the amount of the second material (comprising an absorptive property towards UV light) may be included in one component or the other component or may be divided among the components prior to mixing.

One material that has a reflective property towards UV light or radiation is titanium dioxide (TiO₂). Titanium dioxide is for example a solid of a rutile titanium dioxide such as those commercially available from Chemours of Wilmington, Delaware. The titanium dioxide may have a median particle size on the order of 20 nm to 300 nm, such as 25 nm to 275 nm, such as 30 nm to 250 nm, such as 35 nm to 225 nm, such as 40 nm to 200 nm, such as 50 nm to 175 nm and such as 60 nm to 150 nm as measured by a dynamic laser scanning method (Horiba LA-960 laser particle size analyzer). The particle size can also be measured by TEM, SEM or similar methodologies known to a person of skill in the art. The first material such as titanium dioxide may be present in the coating composition in an amount of 10 percent to 70 percent by weight of the total solids of the coating composition, such as 15 percent to 65 percent by weight, such as 20 percent to 60 percent by weight, such as 25 percent to 55 percent by weight, such as 30 percent to 50 percent by weight, such as 40-50 percent by weight, such as 45-55 percent by weight and such as 35 percent to 45 percent by weight. Another material that comprises a reflective property towards UV light is zinc oxide.

One material that has an absorptive property towards ultraviolet light is carbon black. The carbon black is for example a solid powder such as available from Birla Carbon of Marietta, Georgia. The carbon black may have a median particle size of 20 nm to 200 nm, such as 25 nm to 175 nm, such as 30 nm to 150 nm, such as 35 nm to 150 nm, such as 40 nm to 125 nm, such as 50 nm to 100 nm and such as 60 nm to 100 nm as measured by a dynamic laser scanning method (Horiba LA-960 laser particle size analyzer). The particle size can also be measured by TEM, SEM or similar methodologies known to a person of skill in the art. The second material such as carbon black may be present in the coating composition in an amount of 0.1 percent to 10 percent by weight of the total solids of the coating composition, such as 0.2 percent to 8 percent by weight, such as 0.3 percent to 7 percent by weight, such as 0.4 percent to 6 percent by weight, such as 0.5 percent to 5 percent by weight and such as 1 percent to 4 percent by weight. Other material that comprises an absorptive property towards UV light is graphite and graphene.

A suitable ratio of an amount of a first material comprising a reflective property towards UV light to an amount of a second material comprising an absorptive property towards UV light in a coating composition (e.g., TiO₂:carbon black) may representatively be on the order of 30:1 to 1:1, such as 25:1, such as 20:1, such as 15:1, such as 10:1 and such as 5:1.

In addition to a film-forming resin, an amount of a first material comprising a reflective property towards UV light and an amount of a second material comprising an absorptive property towards UV light, a coating composition may include at least one other optional ingredient or additive. Such optional ingredients may include, for example, other pigments, dyes, surface active agents, flow control agents, thixotropic agents, fillers, anti-gassing agents, organic co-solvents, catalysts, antioxidants, stabilizers, UV absorbers, dispersing agents and other customary auxiliaries. Any such additives known in the art can be used, absent compatibility problems. An example of a suitable filler is an inorganic filler that has UV inhibiting properties (e.g., UV reflective or blocking properties, UV absorbing properties). An example of a suitable filler that comprises a UV reflective property is zinc oxide (ZnO). A filler that comprises a UV reflective property may, in one example, be substituted for a portion of a suitable amount of the first material comprising a reflective property towards UV light. For example, where the first material in a coating composition that comprises a reflective property towards UV light comprises TiO₂, an amount of suitable filler that comprises a UV reflective property may be substituted for amounts of the first material, such as up to 75 percent of a suitable amount of TiO₂, such as up to 50 percent of a suitable amount of TiO₂, such as up to 25 percent of a suitable amount of TiO₂, such as up to 15 percent of a suitable amount of TiO₂ or such as up to 5 percent of a suitable amount of TiO₂ (an amount of TiO₂ in a coating composition may be 25 percent or more of a suitable amount with the remainder replaced by a filler comprising a UV reflective property, such as 50 percent or more, such as 75 percent or more, such as 85 percent or more or such as 95 percent or more). Similarly, a suitable filler may be an inorganic filler that comprises UV absorbing properties, such as graphite or graphene. A filler that comprises UV absorbing properties may, in one example, be substituted for a portion of a suitable amount of the second material in the coating composition comprising an absorptive property towards UV light. For example, where the second material in a coating composition that comprises an absorptive property towards UV light comprises carbon black, an amount of a suitable filler that comprises a UV absorptive property may substituted for amounts of the second material, such as up to 75 percent of a suitable amount of carbon black, such as up to 50 percent of a suitable amount of carbon black, such as up to 25 percent of a suitable amount of carbon black, such as up to 15 percent of a suitable amount of carbon black or such as up to 5 percent of a suitable amount of carbon black (an amount of carbon black in a coating composition may be 25 percent or more of a suitable amount with the remainder replaced by a filler with UV absorbing properties, such as 50 percent or more, such as 75 percent or more, such as 85 percent or more or such as 95 percent or more).

In addition to fillers that may have UV inhibiting properties, organic and inorganic fillers may also be utilized in a coating composition. Representative organic fillers that may be introduced include cellulose, starch, and acrylic. Representative inorganic fillers that may be introduced include borosilicate, aluminosilicate, calcium inosilicate (Wollastonite), mica, silica, zeolite, perlite, talc, barium sulfate and calcium carbonate. The organic and inorganic fillers may be solid, hollow, multicellular, or layered in composition and may range in size from 10 nm to 1 mm in at least one dimension, measured, for example by TEM or SEM.

Exemplary suitable pigments include inorganic pigments such as iron oxide, chromium oxide and lead chromate and organic pigments such as phthalocyanine blue and phthalocyanine green, carbazole violet, anthrapyrimidine yellow, flavanthrone yellow, isoindoline yellow, indanthrone blue, quinacridone violet and perylene reds.

Stabilizers may be blended to prevent reduction of molecular weight by heating, gelation, coloration, generation of an odor and the like in the hot melt adhesive to improve the stability of the coating composition. Stabilizers that may be used in the composition disclosed herein are not particularly limited. Examples of stabilizers useful in the composition disclosed herein include an antioxidant, an ultraviolet absorbing agent, or combinations thereof. Examples of the antioxidant include phenol-based antioxidants, sulfur-based antioxidants, and phosphorus-based antioxidants. The ultraviolet absorbing agent may be used to improve the light resistance of the disclosed compositions. Examples of the ultraviolet absorbing agent include benzotriazole-based ultraviolet absorbing agents and benzophenone-based ultraviolet absorbing agents. Specific examples of suitable stabilizers include SUMILIZER GM (trade name), SUMILIZER TPD (trade name) and SUMILIZER TPS (trade name) manufactured by Sumitomo Chemical Co., Ltd., IRGANOX 1010 (trade name), IRGANOX HP2225FF (trade name), IRGAFOS 168 (trade name), IRGANOX 1520 (trade name) and TINUVIN manufactured by Ciba Specialty Chemicals, JF77 (trade name) manufactured by Johoku Chemical Co., Ltd., TOMINOX TT (trade name) manufactured by API Corporation and AO-4125 (trade name) manufactured by Adeka Corporation.

A coating composition may also include adhesion promoting agents, such as alkoxysilane adhesion promoting agents, for example, acryloxyalkoxysilanes, such as γ-acryloxypropyltrimethoxysilane and methacrylatoalkoxysilane, such as γ-methacryloxypropyltrimethoxysilane, gamma-methacryloxypropyltriethoxysilane and gamma-methacryloxypropyltris (2-methoxyethoxy)silane as well as epoxy-functional silanes, such as beta-(3,4-epoxycyclohexyl)ethyltrimethoxysilane or γ-glycidoxypropyltrimethoxysilane. Other suitable alkoxysilanes include vinyl alkoxysilanes, ethylenically unsaturated acyloxysilanes, mercapto functional silanes, amino functional silanes, and epoxy functional silanes. Exemplary vinyl alkoxysilanes include vinyltrimethoxysilane, vinyltriethoxysilane and vinyltris (2-methoxyethoxy) silane. Exemplary ethylenically unsaturated acyloxysilanes include acrylato-, methacrylato- and vinyl-acetoxysilanes like vinylmethyldiacetoxysilane, acrylatopropyltriacetoxysilane, and methacrylatopropyltriacetoxysilane. Exemplary mercapto functional silanes include gamma-mercaptopropyltrimethoxysilane, gamma-mercaptopropyltriethoxysilane, and gamma-mercaptopropyltrisopropoxysilane. Exemplary amino functional silanes include bis-(gamma-trimethoxysilylpropyl) amine, N-phenyl-gamma-amino propyltrimethoxysilane, and cyclohexyl-gamma-aminopropyltrimethoxysilane. The alkoxysilanes may be polymeric like an acrylic polymer containing a plurality of alkoxysilane groups. Alkoxysilane functional acrylic polymers can be prepared by copolymerizing various ethylenically unsaturated alkoxy functional monomers such as the acryloxysilanes mentioned above with other ethylenically unsaturated monomers via solution polymerization techniques in the presence of suitable initiators. The polymerization is carried out in an organic solution utilizing techniques which are known in the art.

For a 2K system, such as an epoxy amine resin including a first component and a second component, any optional ingredient such as those listed above as well as any adhesion promoting agent may be included in one component or the other component or may be divided among the components prior to mixing of the separate components. Alternatively, an optional ingredient may be included in a kit as a third component to be added to the first component, the second component and/or the combination of the first component and the second component. One example of an optional ingredient that may be included in a kit as a third component is a stabilizer that is an organic UV absorber or absorbing agent.

The coating composition described may be prepared by any of a variety of methods. For example, for a coating composition that is a 2K coating composition, the previously described first material comprising a reflective property towards UV light and the second material comprising an absorptive property towards UV light may be added at any time to the first component and/or the second component during the formulation of the individual components of a coating composition comprising a film-forming resin, so long as they form a stable dispersion in a film-forming resin. A 2K coating composition can be prepared by first separately mixing each of the first component and the second component of the film-forming resin with the previously described pigments, fillers, if any, and diluents, such as organic solvents, dispersing the separate component mixtures with a high-speed disperser at, for example, 1000 to 2000 RPM for 10 to 30 minutes, and then passing the separate dispersions through a paint mill to achieve grinding fineness of 5 plus as checked with a grinding gauge. To form a coating composition, the second component dispersion may be added to the first component dispersion and mixed to a homogenous mixture. Any optional third component may then be added to the mixture with additional mixing. For a one component (1K) coating composition, the previously described first material comprising a reflective property towards UV light and the second material comprising an absorptive property towards UV light may be added at any time during the formulation of the coating composition comprising a film-forming resin, so long as they form a stable dispersion in a film-forming resin. A 1K coating composition may be mixed with a high-speed disperser at, for example, 1000 to 2000 RPM for 10 to 30 minutes, and then passing the dispersion through a paint mill to achieve grinding fineness of 5 plus as checked with a grinding gauge.

The described coating composition may be applied to a substrate by known application techniques, such as dipping or immersion, spraying, intermittent spraying, dipping followed by spraying, spraying followed by dipping, brushing, or by roll-coating. Usual spray techniques and equipment for air spraying and electrostatic spraying, either manual or automatic methods, can be used.

A coating composition as described herein can be applied to various substrates, such as carbon-fiber reinforced polymer substrates as well as substrates of other organic material such as thermoset epoxy composite substrates, polyurethane, epoxy-coated substrates, plastic substrates. including vinyl substrates and foam, including elastomeric substrates and the like. Other suitable substrates include, but are not limited to, metal, glass, wood, fabric or cloth, and leather. For example, suitable substrates include rigid metal substrates such as ferrous metals, aluminum, aluminum alloys, magnesium titanium, copper, and other metal and alloy substrates. The ferrous metal substrates used may include iron, steel, and alloys thereof. Non-limiting examples of useful steel materials include cold rolled steel, galvanized (zinc coated) steel, electrogalvanized steel, stainless steel, pickled steel, zinc-iron alloy such as GALVANNEAL, and combinations thereof. Combinations or composites of ferrous and non-ferrous metals can also be used. Aluminum alloys of the 1XXX, 2XXX, 3XXX, 4XXX, 5XXX, 6XXX or 7XXXseries as well as clad aluminum alloys and cast aluminum alloys of the A356, 1XX.X. 2XXX, 3XXX, 4XXX. 5XXX, 6XXX or 7XX.X series also may be used as the substrate. Magnesium alloys of the AZ31B, AZ91C, AM60B, or EV31A series also may be used as the substrate. The substrate also may comprise titanium and/or titanium alloys of grades 1-36 including H grade variants. Other suitable non-ferrous metals include copper and magnesium, as well as alloys of these materials. In examples, the substrate may be a multi-metal article. As used herein, the term “multi-metal article” refers to (1) an article that has at least one surface comprised of a first metal and at least one surface comprised of a second metal that is different from the first metal, (2) a first article that has at least one surface comprised of a first metal and a second article that has at least one surface comprised of a second metal that is different from the first metal, or (3) both (1) and (2).

The coating composition described herein may be applied directly to a surface of a substrate or applied to a coating or coating already present on the surface of the substrate. A surface of the substrate or an underlying coating on the substrate may be abraded such as through the use of sandpaper prior to application of the coating composition.

The coating composition described herein may be applied to substrates for a variety of purposes including, but not limited to, as a primer coating, a base coating, or a top coating. The coating composition described herein has a property to inhibit a transmission of ultraviolet (UV) radiation to a substrate, particularly UV radiation with a wavelength of 290 nm to 550 nm through the coating and thereby protect the substrate or a surface of the substrate from degradation due to UV radiation exposure. Substrates that may receive a coating composition as described herein include, but are not limited to aerospace components, including aircraft components, such as skins that make up the cockpit, fuselage, wings, stabilizers and rudder. An aircraft is an example of a vehicle. UV light can cause a breakdown in coating compositions on an aircraft and ultimately damage the underlying substrates. The coating composition described herein can inhibit or block 99.5 percent UV light transmission (UV radiation with a wavelength of 290 nm to 550 nm) therethrough, such as 99.6 percent, 99.7 percent, 99.8 percent or 99.9 percent. Such inhibition or blocking may protect the underlying substrate as well as any underlying coatings from degradation. In addition to aircraft, a coating composition as described herein may be utilized on substrates that are components in other vehicles, including automotive components (e.g., exterior body parts of automobiles), as well as other aerospace components (e.g., components of satellites, rockets, capsules), industrial components and household or building components. For example, suitable substrates include without limitation, vehicular door, body panels, trunk deck lid, roof panel, hood, roof and/or stringers, rivets, landing gear components, and/or skins used on an aircraft, a vehicular frame, vehicular parts, motorcycles, and industrial structures and components. As used herein, “vehicle” or variations thereof includes, but is not limited to, civilian, commercial, and military aircraft, and/or land vehicles such as cars, motorcycles, and/or trucks. The coating composition disclosed herein is suitable for use in various industrial or transportation applications including automotive, light and heavy commercial vehicles, marine, or aerospace.

A coating composition as described herein, wherein when formed into a cured coating on a substrate (either after application directly to contact a surface of a substrate or after application to a layer or layers on the surface), may yield a transmission of ultraviolet light (i.e., light transmitted through the cured coating) in the range of 280 nanometers to 550 nanometers through the cured coating of 0.4 percent of maximum transmission or less, such as 0.3 percent or less, such as 0.2 percent or less, such as 0.1 percent or less. The UV inhibition properties of the coating composition when cured, can reduce UV-induced degradation of the substrate or substrate surface, such as UV-induced degradation of a carbon-fiber reinforced polymer substrate.

After application of the coating composition described herein to a substrate, a film or layer is formed on the surface of the substrate by driving solvent, e.g., organic solvent, out of the film by heating or by an air-drying period. Suitable drying conditions will depend on the particular coating composition applied and/or application, but in some instances a drying time of from about one to 60 minutes at a temperature of about 50 to 250° F. (10 to 121° C.) will be sufficient. More than one layer of the coating composition may be applied if desired, such as to further reduce light transmission to an underlying substrate or layer on the substrate. Between coats, the previously applied coat may be flashed; that is, exposed to ambient conditions (e.g., 20° C. (68° F.) to 30° C. (86° F.) and pressure of 1 atmosphere) for 3 to 30 minutes. A thickness of a coating formed from the coating composition may representatively be from 0.1 to 3 mils (2.5 to 75 microns), such as 0.2 to 2.0 mils (5.0 to 50 microns), such as 1.0 mils (25 microns) and such as 0.6 to less than 1.0 mils (15 to less than 25 microns). Additional coatings may then be applied to the coating formed from the coating composition (e.g., topcoat, clear, etc.). The coating layer(s) may then be cured. In a curing operation, solvents are driven off and crosslinkable components of the composition of any of the layers or film, if any, are crosslinked. The curing operation is sometimes carried out at a temperature in the range of from 80 to 250° F. (27 to 121° C.) but, if needed, lower or higher temperatures may be used. In an example of a use of a coating composition described herein, the coating composition may serve as a primer on a surface of a substrate, such as a carbon-fiber reinforced polymer substrate. A surface of the substrate on which the coating composition is to be applied may be abraded such as via a sanding operation (sandpaper) and then wiped with a solvent (e.g., isopropyl alcohol) prior to application of the coating composition. The coating composition may then be applied to the substrate. A representative thickness of the coating composition on a surface of a substrate as a primer is a coating composition applied to a thickness of 1 mil (25 microns) or less, such as 0.5 mils to 1 mils (12.5 to 25 microns), such as 0.5 mils to less than 1 mils. After application of the coating composition as described herein to the substrate, a topcoat may be applied on the top of the coating composition in case of multi-layer coating system if desired. Between coats, the previously applied coat may be flashed; that is, exposed to ambient conditions for 1 to 72 hours, such as 2 to 24 hours. A thickness of the topcoat coating is, for example, from 0.5 to 4 mils (12.5 to 100 microns), such as 1.0 to 3.0 mils (25 to 75 microns). The multi-layer coating (coating composition and topcoat) may then be heated or cured. In a curing operation, solvents are driven off and crosslinkable components of the composition, if any, are crosslinked. The heating and curing operation is sometimes carried out at a temperature in the range of from 80 to 250° F. (27 to 121° C.) but, if needed, lower or higher temperatures may be used. A subsequent coating or coatings may be added onto the topcoat coating, such as a clear coating or multiple clear coatings.

### EXAMPLES

### Formulation

Table 1 presents the formulation of two control coating compositions that are formulated as primer coating compositions. Control 1 contains 28.2 grams titanium dioxide and no carbon black and Control 2 containing 1.2 grams carbon black and no titanium dioxide. As indicated in Table 1, the Control 1 coating composition is formulated with 63.3 percent by weight of titanium dioxide based on total solid materials. The Control 2 coating composition is formulated with 3.3 percent by weight of carbon black based on total solid materials. An amount of barium sulfate filler is included in the Control 2 to account for the weight difference due to the absence of titanium dioxide. Each of the Control 1 and 2 coating composition also includes a UV absorber, Tinuvin 477, in an amount of 1.6 percent by weight and 1.5 percent by weight, respectively.

Table 2 presents the formulation of two example coating compositions as described herein each formulated as primer coating compositions including amounts of titanium dioxide and carbon black. As shown in Table 2, the coating composition of Example 1 is formulated with 24.1 percent by weight of titanium dioxide and 3 percent by weight of carbon black based on total solid material. The coating composition of Example 2 is formulated with 60.6 percent by weight of titanium dioxide and 4 percent by weight of carbon black based on total solid material. Neither the coating composition of Example 1 nor of Example 2 includes an additional UV absorber as in the control compositions.

Table 3 presents the formulation of two example coating compositions as described herein including amounts of titanium dioxide and carbon black. Example 3 substitutes an amount of the carbon black for graphene and Example 4 substitutes an amount of TiO₂ for ZnO. As shown in Table 3, the coating composition of Example 3 is formulated with 48.8 percent by weight of titanium dioxide; 1.6 percent by weight of carbon black; and 1.6 percent by weight of graphene black based on total solid material. The coating composition of Example 4 is formulated with 24.1 percent by weight of titanium dioxide; 24.2 percent by weight of zinc oxide; and 3 percent by weight of carbon black based on total solid material. Neither the coating composition of Example 3 nor of Example 4 includes an additional UV absorber as in the control compositions.

TABLE 1
Composition of the Control Examples

| | Control 1 (TiO2 only) | | | Control 2 (Black only) | | |
|---|---|---|---|---|---|---|
| | | Solid by | Solid | | Solid by | Solid |
| | Weight | weight | Percentage by | Weight | weight | Percentage by |
| CHEMICAL | (Grams) | (Grams) | Weight(wt %) | (Grams) | (Grams) | Weight(wt %) |
| ANCAMIDE 2050¹ | 8.2 | 5.8 | 13.0 | 9.3 | 6.5 | 17.6 |
| ANCAMINE K-54² | 0.3 | 0.3 | 0.6 | 0.3 | 0.3 | 0.8 |
| Dispersing agent | 0.6 | 0.3 | 0.7 | 0.7 | 0.4 | 1.0 |
| RAVEN 14³ | 0.0 | 0.0 | 0.0 | 1.2 | 1.2 | 3.3 |
| Ti-Pure R-706⁴ | 28.0 | 28.0 | 63.3 | 0.0 | 0.0 | 0.0 |
| SACHTLEBAN | 0.0 | 0.0 | 0.0 | 17.6 | 17.6 | 47.6 |
| BLANC FIXE⁵ | | | | | | |
| n-BUTYL | 12.5 | 0.0 | 0.0 | 14.1 | 0.0 | 0.0 |
| ALCOHOL | | | | | | |
| SILQUEST A-187⁶ | 0.3 | 0.3 | 0.6 | 0.3 | 0.3 | 0.8 |
| EPON RESIN 828⁷ | 9.0 | 9.0 | 20.2 | 10.1 | 10.1 | 27.4 |
| Oxsol 100⁸ | 41.2 | 0.0 | 0.0 | 46.5 | 0.0 | 0.0 |
| TINUVIN 477⁹ | 0.7 | 0.7 | 1.6 | 0.6 | 0.6 | 1.5 |
| Total | 100.7 | 44.3 | 100.0 | 100.6 | 36.9 | 100.0 |
| Non-Volatile | 44.0% | | | 36.7% | | |
| Material (NVM %) | | | | | | |

¹Polyamide resin, Evonik Industries AG, Germany
²Amine catalyst, Evonik Industries AG, Germany
³Carbon black, Birla Carbon, Marietta, Georgia
⁴Titanium dioxide, Chemours Wilmington, Delaware
⁵Barium sulfate filler, Sachtleben Chemie GmbH, Schoningen, Germany
⁶Adhesion promoter, Momentive Specialty Chemicals, Waterford, New York
⁷Epoxy resin, Westlake, Stafford, Texas
⁸Solvent, Sigma-Aldrich, St. Louis, Missouri
⁹UV Absorber, BASF Corporation, Southfield, Michigan

TABLE 2
Coating Composition Examples 1&2

| | Example 1 | | | Example 2 | | |
|---|---|---|---|---|---|---|
| | | Solid by | Solid | | Solid by | Solid |
| | Weight | weight | Percentage by | Weight | weight | Percentage by |
| CHEMICAL | (Grams) | (Grams) | Weight(wt %) | (Grams) | (Grams) | Weight(wt %) |
| ANCAMIDE 2050 | 8.9 | 6.2 | 16.0 | 8.2 | 5.7 | 13.1 |
| ANCAMINE K-54 | 0.3 | 0.3 | 0.7 | 0.3 | 0.3 | 0.6 |
| Dispersing agent | 0.7 | 0.3 | 0.9 | 0.6 | 0.3 | 0.7 |
| RAVEN 14 | 1.2 | 1.2 | 3.0 | 1.8 | 1.8 | 4.0 |
| Ti-Pure R-706 | 9.4 | 9.4 | 24.1 | 26.6 | 26.6 | 60.6 |
| SACHTLEBAN | 11.5 | 11.5 | 29.6 | 0.0 | 0.0 | 0.0 |
| BLANC FIXE | | | | | | |
| n-BUTYL ALCOHOL | 13.5 | 0.0 | 0.0 | 12.4 | 0.0 | 0.0 |
| SILQUEST A-187 | 0.3 | 0.3 | 0.7 | 0.3 | 0.3 | 0.6 |
| EPON RESIN 828 | 9.7 | 9.7 | 25.0 | 8.9 | 8.9 | 20.4 |
| Oxsol 100 | 44.6 | 0.0 | 0.0 | 41.0 | 0.0 | 0.0 |
| Total | 100.0 | 38.9 | 100.0 | 100.0 | 43.8 | 100.0 |
| Non-Volatile | 38.9% | | | 43.8% | | |
| Material (NVM %) | | | | | | |

TABLE 3
Coating Composition Examples 3&4

| | Example 3 (TiO2/Black/Graphene) | | | Example 4 (ZnO/TiO2/Black) | | |
|---|---|---|---|---|---|---|
| | | Solid by | Solid | | Solid by | Solid |
| | Weight | weight | Percentage by | Weight | weight | Percentage by |
| CHEMICAL | (Grams) | (Grams) | Weight(wt %) | (Grams) | (Grams) | Weight(wt %) |
| ANCAMIDE 2050 | 8.9 | 6.2 | 15.8 | 8.9 | 6.2 | 16.0 |
| ANCAMINE K-54 | 0.3 | 0.3 | 0.7 | 0.3 | 0.3 | 0.7 |
| Dispersing agent | 0.7 | 0.3 | 0.9 | 0.7 | 0.3 | 0.9 |
| RAVEN 14 | 0.6 | 0.6 | 1.6 | 1.2 | 1.2 | 3.0 |
| Graphene Black | 0.6 | 0.6 | 1.6 | 0.0 | 0.0 | 0.0 |
| Ti-Pure R-706 | 19.2 | 19.2 | 48.8 | 9.4 | 9.4 | 24.1 |
| ZnO | 0.0 | 0.0 | 0.0 | 9.4 | 9.4 | 24.2 |
| SACHTLEBAN | 2.1 | 2.1 | 5.4 | 2.1 | 2.1 | 5.4 |
| BLANC FIXE | | | | | | |
| n-BUTYL ALCOHOL | 13.4 | 0.0 | 0.0 | 13.5 | 0.0 | 0.0 |
| SILQUEST A-187 | 0.3 | 0.3 | 0.7 | 0.3 | 0.3 | 0.7 |
| EPON RESIN 828 | 9.7 | 9.7 | 24.6 | 9.7 | 9.7 | 25.0 |
| Oxsol 100 | 44.3 | 0.0 | 0.0 | 44.6 | 0.0 | 0.0 |
| Total | 100.0 | 39.2 | 100.0 | 100.0 | 38.9 | 100.0 |
| Non-Volatile | 39.2% | | | 38.9% | | |
| Material (NVM %) | | | | | | |

### Transmission Intensity Analysis

### Sample Preparation

A quartz substrate is used for UV-Vis intensity measurement. The coating compositions (Control 1, Control 2, and Examples 1-4) are applied by spraying onto a quartz substrate at a dry film thickness of less than or equal to 1.0 mils (25.4 microns). The samples were air dried at 70° C. for 2 hours.

### Transmission Intensity Measurement

Samples were submitted for transmission analysis in the 290 nanometer (nm) to 550 nm range on a Perkin Elmer Lambda 950 UV/Vis/NIR spectrometer (CAL C11535). Background references were collected for 0% T (dark-current) and 100% T (Spectralon standard) prior to data collection. Each sample was mounted onto the diffuse transmittance port of the 150 mm integration sphere with InGaAs (NIR) and PMT (UV/Vis) photodetectors for measurement (5 second integration time per 2 nm step). A change between the two light sources (Tungsten Halogen and Deuterium) occurs at 319 nm. Subtle intensity variations of <0.5% T on average occur between about 319 nm and 350 nm due to the low power of the lamp at these wavelengths.

### Transmission Intensity Measurement Results

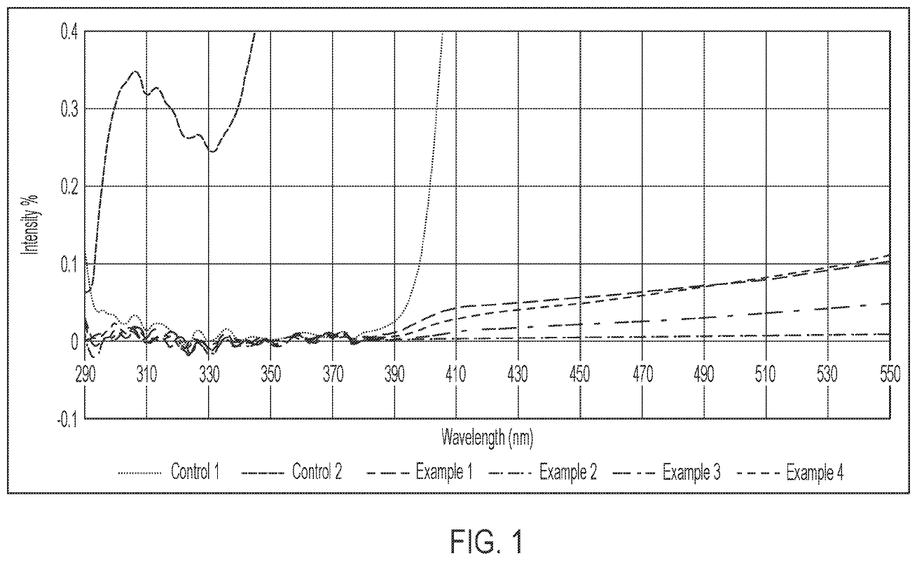

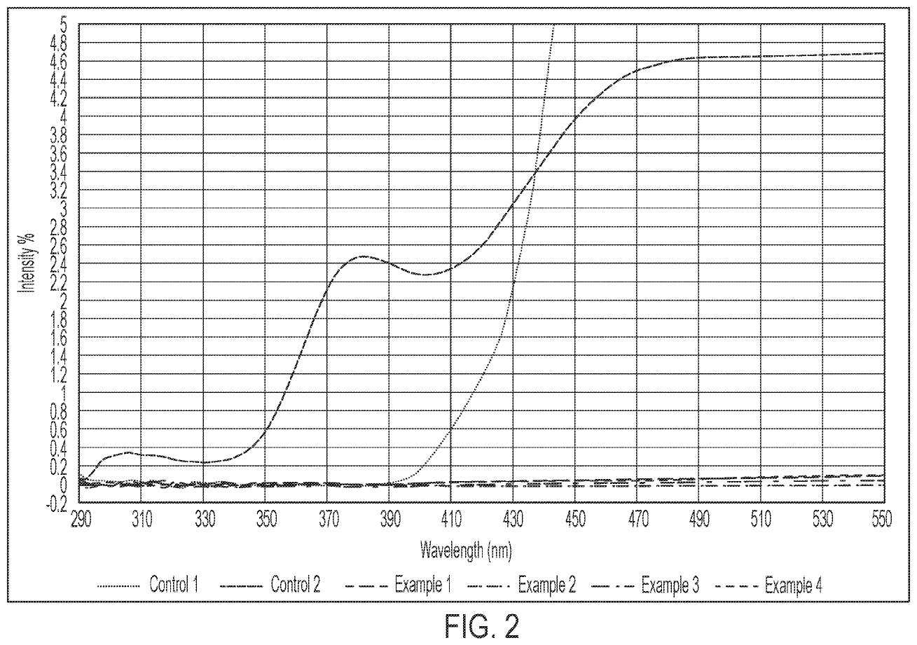

FIG. 1 illustrates transmission intensity data of coatings formed from the individual coating compositions (Control 1, Control 2, and Examples 1-4) on a quartz substrate in the wavelength range of 290 nm to 550 nm as plotted with 0.4 percent of maximum transmission. FIG. 2 illustrates the transmission intensity data of the coatings formed from the individual coating compositions (Control 1, Control 2, and Examples 1-4) on a quartz substrate in the wavelength range of 290 nm to 550 nm as plotted with one percent of maximum transmission. The coating of Control 1 is formulated with 63.3 weight percent of titanium dioxide based on total solids and exhibits high light transmission above 390 nm. The coating of Control 2 is formulated with 3.3 weight percent of carbon black based on total solids and exhibits light transmission greater than 0.2 percent at 290 nm.

Without wishing to be bound by theory, a composition containing only titanium dioxide in an amount of 63.3 percent by weight (Control 1) or only carbon black in an amount of 3.3 percent by weight (Control 2) might each inhibit light transmission with the titanium dioxide composition (Control 1) having a tendency to reflect light and the carbon black composition (Control 2) having a tendency to absorb light. FIG. 1 and FIG. 2 show Control 1 yielding more than 0.4 percent transmission of light beyond 390 nm and at least 5 percent at 440 nm. FIG. 1 and FIG. 2 show Control 2 yielding more than 0.4 percent beyond 340 nm, over 2.2 percent between 370 nm and 410 nm and increasing to over 4.5 percent beyond 450 nm. Surprisingly, coatings formed on a quartz substrate from the coating composition of Examples 1-4 demonstrate less light transmission therethrough (greater UV inhibiting properties) than either Control composition even when amounts of TiO₂ and carbon black in an Example composition are less than in either Control composition (e.g., Example 1, Example 3, Example 4). Examples 1-4 showed less than 0.2 percent transmission of light between 290 nm and 550 nm through coatings formed from the coating compositions. The coating composition of Example 1 is formulated with 24.1 percent of titanium dioxide and 3 percent of carbon black based on total solid material. The coating composition of Example 2 is formulated with 60.6 percent of titanium dioxide and 4 percent of carbon black based on total solid material. The coating composition of Example 3 is formulated with 48.8 percent of titanium dioxide, 1.6 percent of carbon black, and 1.6 percent of graphene black based on total solid material. The coating composition of Example 4 is formulated with 24.1 percent of titanium dioxide, 24.2 percent of zinc oxide, and 3 percent of carbon black based on total solid material. As illustrated in FIG. 1, Example 1 and Example 2 show UV transmission of 0.1 percent or less between 290 nm and 550 nm. Examples 3-4 show UV transmission of 0.2 percent or less between 290 nm and 530 nm and less than 0.2 percent between 530 nm and 550 nm.

### Physical Property Analysis

### Sample Preparation

A carbon fiber-reinforced polymer (CFRP) substrate and an aluminum substrate (2024-T3 aluminum) were used for physical properties testing. The CFRP composite substrates were abraded with sandpaper, then wiped clean with isopropyl alcohol. The 2024-T3 aluminum substrates were mechanically abraded, then wiped clean with methyl ethyl ketone (MEK).

The coating compositions (Control 1, Control 2, and Examples 1-4) were prepared as above and applied to the CFRP substrates and the aluminum substrates. The coatings were sprayed with a standard 1.2-1.6 mm tip size HVLP (high volume low pressure) spray gun to a dry film thickness of 0.5-0.6 mils (12.5 μm to 15 μm).

The sprayed panels were cured at 70° C. (160° F.) for two hours prior to adhesion test.

### Crosshatch Adhesion Testing

Crosshatch adhesion was determined according to ASTM D3359 (Standard Test Methods for Measuring Adhesion by Tape Test), method B, 2017. A crosshatch pattern was scribed through the coating down to the substrate. A strip of 1-inch (25.4 mm) wide masking tape (such as 3M 250 or equivalent) was applied onto the scribed coating. The tape was pressed down using two passes of a 4.5-pound rubber covered roller. The tape was then removed in one abrupt motion perpendicular to the panel. The adhesion was rated by a visual examination of the coating at the crosshatch area using the provided rating system. Dry adhesion was tested after fully curing the coating. Wet adhesion was tested on a fully cured coating after immersing the test panel in water at 75° F.). (23° C. for 24 hours. Panels were removed from the water, wiped dry with a paper towel, and tested after 5 minutes. The adhesion of the coating systems was rated as follows:
5B: The edges of the cuts are completely smooth and none of the lattice squares are detached.
4B: Small flakes of the coating are detached at the intersections. Less than 5% of the lattice area is affected.
3B: Small flakes of the coating are detached along edges and at intersections of cuts. The area affected is from 5% to 15% of the lattice.
2B: The coating flaked along the edges and on parts of the squares. The area affected is from 15% to 35% of the lattice.
1B: The coating flaked along the edges of cuts in large ribbons and squares have detached. The area affected is from 35% to 65% of the lattice.
0B: Flaking and detachment worse than for Grade 1B.

The results of the adhesion tests are provided in Table 5. All samples exhibit passing dry and wet adhesion on both CFRP substrates and aluminum substrates.

TABLE 5
Cross-Hatch Adhesion of Control and Example Coatings

| | CFRP | | 2024-T3 Aluminum | |
|---|---|---|---|---|
| Substrate | Dry | Wet | Dry | Wet |
| Test | Adhesion | Adhesion | Adhesion | Adhesion |
| Control 1 | 5B | 5B | 5B | 5B |
| Control 2 | 5B | 5B | 5B | 5B |
| Example 1 | 5B | 5B | 5B | 5B |
| Example 2 | 5B | 5B | 5B | 5B |
| Example 3 | 5B | 5B | 5B | 5B |
| Example 4 | 5B | 5B | 5B | 5B |

The invention has been described with reference to exemplary embodiments and aspects but is not limited thereto. Persons skilled in the art will appreciate that other modifications and applications can be made without meaningfully departing from the invention. For example, although the coating compositions are described as being useful for aerospace or aviation or other vehicle applications, they may be useful for other applications as well such as applications in industrial settings, home settings (including home construction settings) and other. Accordingly, the foregoing description should not be read as limited to the precise embodiments and aspects described but should be read consistent with and as support for the following claims, which are to have their fullest and fair scope.

1. A coating composition comprising:
a film-forming resin present in an amount of 20 percent to 60 percent by weight of the total solids of the coating composition;
an amount of a first material comprising a reflective property towards ultraviolet (UV) light; and
an amount of a second material comprising an absorptive property towards UV light.

2. The coating composition of claim 1, wherein the first material comprises titanium dioxide and/or wherein the second material comprises carbon black.

3. The coating composition of claim 2, wherein the titanium dioxide has a particle size of 20 nanometers to 300 nanometers and/or the carbon black has a particle size of 20 nanometers to 200 nanometers.

4. The coating composition of claim 1, wherein the first material is present in an amount of 10 percent to 70 percent by weight of the total solids of the coating composition and/or the second material is present in an amount of 0.1 percent to 10 percent by weight of the total solids of the coating composition.

5-7. (canceled)

8. The coating composition of claim 1, wherein the film-forming resin comprises an epoxy amine resin.

9. The coating composition of claim 1, further comprising an amount of a third material comprising a reflective property towards ultraviolet light and/or an amount of a fourth material comprising an absorptive property towards ultraviolet light.

10. The coating composition of claim 9, wherein the third material comprising a reflective property towards ultraviolet light comprises zinc oxide and/or wherein the fourth material comprising an absorptive property towards ultraviolet light comprises graphene.

11-12. (canceled)

13. The coating composition of claim 1, wherein the film-forming resin comprises a first component and a second component and the coating composition comprises a kit where the first component and the second component are separated until use.

14. The coating composition of claim 1, wherein a ratio of an amount by weight of the first material comprising a reflective property towards UV light and the second material comprising an absorptive property towards UV light in the coating composition is 30:1 to 1:1.

15. The coating composition of claim 1, wherein when formed into a cured coating on a substrate, the cured coating yields a transmission of ultraviolet light of 280 nanometers to 550 nanometers through the cured coating of 0.2 percent or less.

16. The coating composition of claim 1, wherein when formed into a cured coating on a substrate, the cured coating yields a transmission of ultraviolet light of 280 nanometers to 550 nanometers through the cured coating of 0.1 percent or less.

17. The coating composition of any of claim 1, wherein the coating composition is formulated as a primer.

18. A substrate comprising a surface at least partially coated with the coating composition of claim 1.

19. The substrate of claim 18, wherein the substrate comprises an aerospace component, an automotive component, and/or a carbon-fiber reinforced polymer composite.

20-21. (canceled)

22. The substrate of claim 18, wherein the coating composition, when cured, has a dry film thickness of less than or equal to 1 mils.

23. The substrate of claim 18, further comprising a topcoat layer overlying a portion of the coating composition.

24. A method of preparing a substrate comprising:
coating a portion of a surface of the substrate with the coating composition of claim 1; and
curing the coating composition.

25. The method of claim 24, wherein the coating composition when cured has a dry film thickness of 1 mils or less.

26. The method of claim 24, further comprising, after curing the coating composition, coating the portion of the surface of the substrate with a topcoat layer.

27. A vehicle comprising a surface at least partially coated with the coating composition of claim 1.

28. The vehicle of claim 27, wherein the vehicle is an aircraft and/or an automobile.

29. (canceled)

30. The vehicle of claim 27, wherein the surface comprises a surface of a carbon-fiber reinforced polymer composite.

31. (canceled)
